(19) United States
(12) Patent Application Publication
(10) Pub. No.: US 2009/0210863 A1
(43) Pub. Date: Aug. 20, 2009

(54) CODE-BASED WEBSITE EXPERIMENTS

(75) Inventor: Kenneth Eric Vasilik, Bellevue, WA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/033,364

(22) Filed: Feb. 19, 2008

(51) Int. Cl. G06F 9/44

(52) U.S. Cl. 717/130

(57) ABSTRACT

Systems and methods for code-based website experiments. Code-base website experiments can include specification of an identified section of program code to be experimented upon as well as one or more alternative sections of program code to replace the identified section of program code in the experimental landing page configurations. Statistics associated with the program code sections can be analyzed to determine which of the program code sections performs better than the other program code sections.

### BACKGROUND

This disclosure is related to website experiments.

With the exponential expansion of the internet, electronic commerce (e-commerce) markets have become an integral part of life for many people. Based upon the expansion of the market, many publishers have been created to meet demand. These publishers have increased competition for business. Increased competition has increased the importance of publisher websites. For example, if a website is difficult to navigate, a consumer is likely to leave the website and use a competitors' website.

Tools have been created to help publishers create better websites. One such tool is Website Optimizer, available from Google Inc. of Mountain View, Calif. Such tools can enable publishers to specify several different options for a web page, and then the publisher can run an experiment to determine whether any of several options is better than a current version of the web page based upon a number of conversions (e.g., sales, navigations of a goal path, etc.). The experiment can run for a period of time. During this experiment period, the various options, including the current version, can be served to clients. Statistics associated with each of the various options can be collected and analyzed. Analysis can determine whether any of the specified options performed better than the current version during the experiment period. The results of the analysis can be provided to the publisher, who can then decide whether to implement any of the alternative versions of the web page or to retain a current version of the web page.

### SUMMARY

Systems, methods and computer readable media for code-based website experiments are provided. Example systems can include and interface and a code fragment engine. The interface can identify programming code having one or more sections, and can also identify a specified section from among the one or more sections of programming code and one or more alternative sections of programming code. The code fragment engine can provide code fragments that when executed by a processor can determine which of the specified sections of programming code or any of the one or more alternative sections of programming code to execute.

Example methods for performing code-based website experiments can include: identifying a programming code, the programming code having at least one section; receiving an identification of a first section of programming code; receiving an identification of a first alternative section of programming code associated with the identified first section of programming code; and providing code fragments, the code fragments, when executed by a processor, being operable to determine whether to execute the first section of programming code or the first alternative section of programming code when executing the program code.

Another example method for performing code-based website experiments can include: inserting one or more alternative programming code sections into programming code comprising one or more sections of programming code; identifying a specific section of programming code associated with the one or more alternative sections of programming code, the specific section of programming code being selected from among the one or more sections of programming code; inserting code fragments into the programming code, the code fragments being operable to cause a processor, upon execution of the code fragments, to select and execute code comprising one of the specific section of programming code or any of the one or more alternative sections of programming code; and replacing the specific section of the programming code with one of the one or more alternative sections of programming code based a performance metric respectively associated with the specific section of the programming code and the one or more alternative sections of programming code.

Example computer readable media can be operable to cause a processor to perform steps comprising: identifying programming code, the programming code having at least one section; receiving an identification of a first section of programming code; receiving an identification of a first alternative section of programming code associated with the identified first section of programming code; and providing code fragments, the code fragments, when executed by the processor, being operable to determine whether to execute the first section of programming code or the first alternative section of programming code.

Other implementations are disclosed, including implementations directed to systems, methods, apparatuses, computer-readable mediums and user interfaces.

### BRIEF DESCRIPTION OF THE FIGURES

FIG. 1 is a block diagram of an example network architecture that can provide adaptive website optimization experiments.

FIG. 2 is a block diagram of an example data flow associated with network devices executing an adaptive website optimization experiment.

FIG. 3 is a block diagram of example device components used to execute an adaptive website optimization experiment.

FIG. 4 is a flowchart of an example method for providing an adaptive website optimization experiment.

FIG. 5 is a flowchart of another example method for providing an adaptive website optimization experiment.

### DETAILED DESCRIPTION

Website experiments can be performed to determine whether a publisher can find a landing page configuration that performs better than a current landing page configuration. As websites have become more sophisticated, programming code has been used to provide a more sophisticated interface for the user. However, there can be many configurations for such sophisticated interfaces.

In some implementations, a section of program code can be identified and alternative sections of program code can be associated with the identified sections of program code. A landing page associated with the program code can be instrumented using code fragments. The instrumented landing page can cause a browser to send a request to an experiment server upon loading the instrumented landing page. Upon receiving the request, the experiment server can select whether to use the identified section of program code or an alternative section of program code and can instruct the program code associated with the instrumented landing page to use the selected section of program code. Moreover, in some implementations, the experiment server can collect statistics associated with the identified section of program code and the one or more alternative sections of program code each time a selection associated with a respective section of program code is made. The collected statistics can be analyzed by the experiment server to recommend whether to replace the identified section of program code with one of the alternative sections of program code.

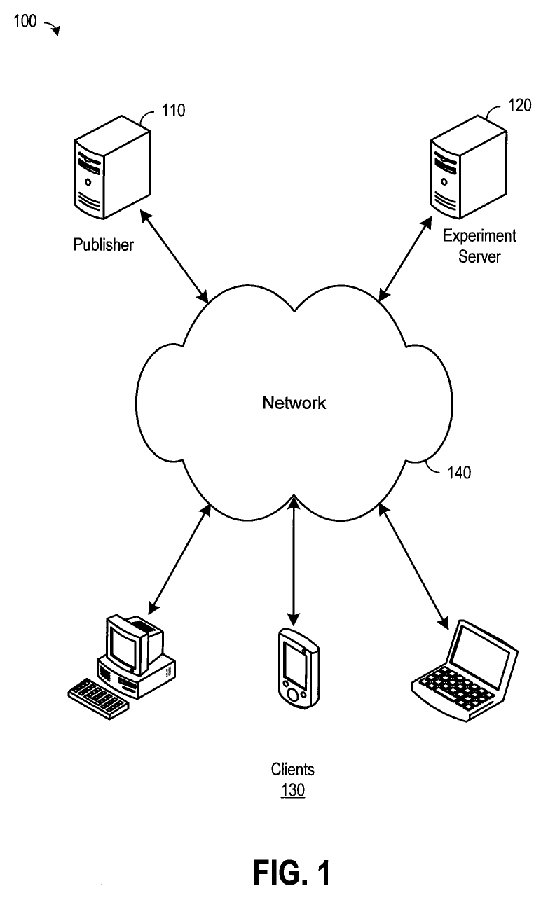

FIG. 1 is a block diagram of an example network architecture 100 that can provide adaptive website optimization experiments. The network architecture 100, in some implementations, can include a publisher 110, an experiment server 120, clients 130 and a network 140. In some examples, the publisher 110 can include a landing page (e.g., a web page) offering a product or service for sale. In various examples, search engines and other third party websites can provide a link (e.g., a universal resource locator (URL)) pointing to the landing page. In an effort to maximize conversions (e.g., sales, progression along a goal path, etc.) from traffic received on the website, the publisher 110 can make changes to the landing page to influence customer experience.

In some implementations, the publisher 110 might want to test multiple variations of a landing page against each other. In such implementations, the publisher 110 can use a website experiment server 120 to collect statistics regarding each of the variations (e.g., the variations of the landing page produced by the different portions of program code specified for the landing page). An example of the website experiment server 120 is Website Optimizer available from Google Inc. of Mountain View, Calif. The publisher 110 can provide experiment parameters to the website experiment server 120 including, for example, program code sections for each of the optional code sections being tested. In other examples, the experiment parameters can include an experiment duration.

In some implementations, the website experiment server 120 can provide a control script to the publisher 110. For example, the control script could be a snippet of hypertext markup language (HTML) or extensible markup language (XML) code. The control script can be inserted into the landing page by the publisher along with each of the landing page variations to produce an instrumented landing page.

In some implementations, the instrumented landing page can be configured to provide statistics back to the website experiment server 120. For example, upon being loaded by a client device 130, the instrumented landing page can communicate with the website experiment server 120 to identify which of the variations of code sections included in the landing page to display on the client. The control script can also communicate with the experiment server 120 responsive to user interaction (e.g., a selection of any links) with the displayed variation of the landing page code.

In other implementations, the website experiment server 120 can act as a proxy server for the publisher 110 and serve a selected code section for the landing page to the client 130. For example, the website experiment server can be associated with a search engine and can provide advertisements including an advertisement for the landing page to the client. Upon selection of a URL associated with the landing page in such examples, the search engine can retrieve an instrumented web page, select the option to be served and serve the option to the client within a search engine environment (e.g., within a frame). Thus, user selections of any of the links (e.g., including submission button representations) associated with the website can be received and logged by the website experiment server 120.

In yet another implementation, a server can provide an advertisement associated with the instrumented landing page to client devices. Upon selection of the advertisement, the server in conjunction with the website experiment server can send the request to the publisher along with an instruction regarding which variation of the landing page code section to serve to the client 130. The landing page served to the client 130 can include a control script operable to communicate any customer actions (e.g., selection of any hyperlinks or button representations) on the landing page back to the experiment server 120. The experiment server 120 can collect and compile the statistics associated with the variation served to the client device 130.

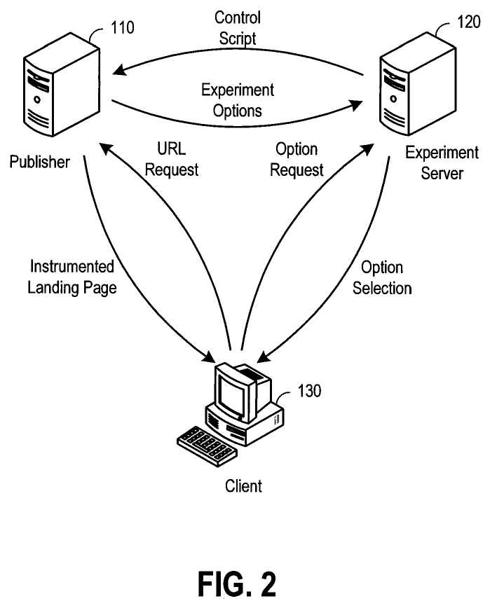

FIG. 2 is a block diagram of an example data flow associated with network devices executing a code-based website experiment. In various implementations, a publisher 110 can communicate experiment options, for example, including sections of alternative program code and an identified section of current program code to an experiment server 120. The experiment server 120 can respond by providing a control script, for example, including one or more code fragments to the publisher 110 for inclusion in the landing page code. The publisher 110 can insert the control script into a landing page to produce an instrumented landing page.

In various implementations, the instrumented landing page can facilitate the collection of data associated with the instrumented landing page. For example, a client 130 can send a URL request to the publisher 110 to request the landing page. The publisher 110 can respond to the URL request by providing the instrumented landing page to the client 130. The instrumented landing page, when loaded by a client 130 can cause the client 130 to communicate with the experiment server 120.

In some implementations, the instrumented landing page can request which of a number of program code sections included in the instrumented landing page should be used to generate portions displayed by the client. For example, an instrumented landing page might include five optional program code sections to produce various landing page configurations. The control script included in the instrumented landing page can, for example, cause the client 130 to communicate with the experiment server 120 to determine which of the five options are to be displayed by the client 130.

The experiment server 120 can operate to determine which of the optional program code sections associated with various landing page configurations should be executed resulting in a display by the client 130. In some implementations, the experiment server 120 can provide instructions that operate to provide a random or pseudo-random distribution of each of the optional program code sections to requesting clients 130. For example, a random distribution would randomly select a selected program code section from among the optional program codes sections to instruct the instrumented landing page to display to the client 130. Thus, the chance that any particular optional program code section is chosen for display to the user is equal to the chance that any other optional program code section is chosen for display to the user.

In some implementations, the experiment server 120 can collect statistics for each of the optional program code sections associated with the instrumented landing page. For example, code fragments associated with the instrumented landing page can communicate navigation information back to the experiment server. In other examples, the experiment server 120 can serve as a proxy by receiving URL requests from a client through the instrumented landing page, and forwarding the URL requests to the publisher. In such examples, the experiment server 120 can collect statistics based upon the URL requests received from the client executing the instrumented landing page.

The experiment server 120 can provide the results of the code-based website experiment to the publisher 110, for example, at the end of an experiment period.

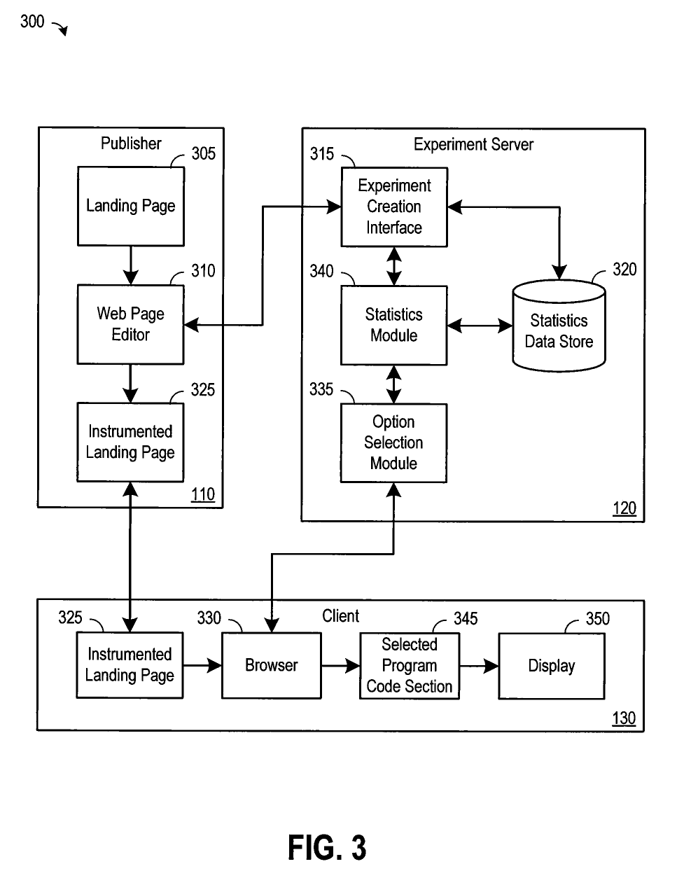

FIG. 3 is a block diagram of example device components used to execute a code-based website experiment. A publisher device 110 can author a landing page 305 used to make a conversion (e.g., sell a product, direct users to another site, etc.). In some implementations, the publisher device 110 can include an editor 310 which can be used to create and edit the landing page. For example, if the publisher 110 wants to edit his/her landing page, the publisher 110 can use the editor to create an edited landing page.

In some implementations, the publisher 110 might decide to test a new version (or versions) of a program code section against a current version of the landing page. In such instances, the publisher 110 can communicate with an experiment creation interface 315 on an experiment server 120. The experiment creation interface 315 can facilitate the creation of an experiment. For example, the publisher 110 can provide his/her optional program code sections to the experiment creation interface 315 using the editor 310. In some implementations, the publisher 110 can also provide an experiment duration.

The experiment creation interface 315 can store the parameters associated with the experiment in a statistics data store 320. In some implementations, the experiment creation interface 315 can also provide a control script to the publisher 110. The publisher 110 can insert the control script into the landing page 305 using the editor 310 to produce an instrumented landing page 325.

In some implementations, the instrumented landing page 325 can be provided to a client 130 based upon a request (e.g., URL request) received from the client 130. The client 130 can include a browser 330 operable to load the instrumented landing page 325 received from the publisher 110. The browser 330, upon loading the instrumented landing page 325, will encounter the control script previously inserted into the instrumented landing page 325 by the publisher 110. The control script can cause the browser 330 to send a communication to an option selection module 335 at the experiment server 120.

In some implementations, the option selection module 335 can select a selected program code section from the optional landing page configurations. For example, the option selection module can randomly or pseudo-randomly select from among the available program code sections (e.g., the current program code section and alternative program code sections). The option selection module 335 can provide instructions to the instrumented landing page 325 to execute such randomly/pseudo-randomly selected program code section 345 resulting in a variation of the landing page for presentation on the display 350.

In various implementations, statistics can be collected throughout the experiment. For example, every time a communication is received from the client 130, the communication can be logged to the statistics data store 320 by a statistics module 340. In some implementations, the statistics module 340 can periodically (e.g., every two hours) update an analysis of the statistics. In other implementations the statistical analysis of the collected statistics stored in the statistics data store 320 can be updated every time a request is received from the client 130. In such implementations, a current analysis of the statistics can be served to the publisher 110 upon request.

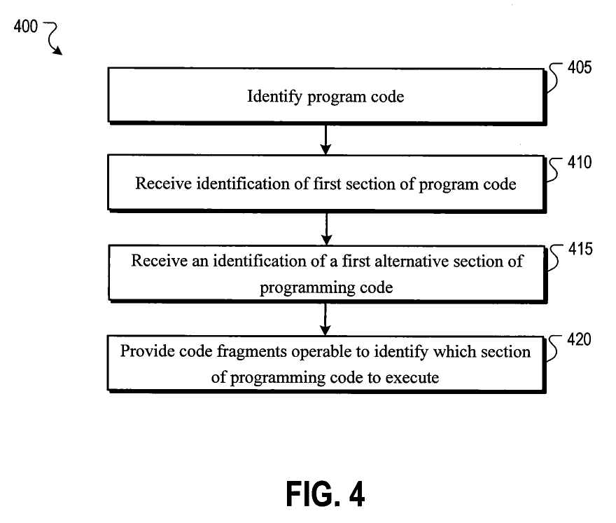

FIG. 4 is a flowchart of an example method 400 for performing code-based website experiments. At stage 405, program code is identified. The program code can be identified, for example, by a publisher (e.g., publisher 110 of FIG. 3) in conjunction with an editor (e.g., editor 310 of FIG. 3). In some implementations, the program code can be preexisting hypertext markup language program code defining a landing page and can be provided to an experiment server (e.g., experiment server 120 of FIG. 3) by the publisher. The program code can be operable to cause a browser client to display content associated with the program code.

At stage 410, identification of a first section of program code can be received. The identification of the first section of program code can be received, for example, by an experiment server (e.g., experiment server 120 of FIG. 3) from a publisher (e.g., publisher 110 of FIG. 3). In some implementations, the identification of a first section of program code identifies the section of program code on which the publisher would like to perform an experiment. For example, if a program code associated with a landing page included program code sections A, B, C, and D, the publisher could identify program code section “C” as the subject of the experiment.

At stage 415, identification of a first alternative section of programming code can be received. Identification of a first alternative section of programming code can be received, for example, by an experiment server (e.g., experiment server 120 of FIG. 3) from a publisher (e.g., publisher 110 of FIG. 3) in conjunction with an editor (e.g., editor 310 of FIG. 3). For example, the publisher can create an alternative section of program code to include with the landing page in addition to the identified first section of program code.

At stage 420, code fragments operable to identify which section of programming code to execute can be provided. Code fragments can be provided, for example, by an experiment server (e.g., experiment server 120 of FIG. 3) to a publisher (e.g., publisher 110 of FIG. 3). In some implementation, the code fragments can be inserted into the code associated with a landing page to create an instrumented landing page. The instrumented landing page can be operable to cause a browser to communicate with the experiment server upon loading the instrumented web page. For example, when a user device submits a URL request to receive the landing page using a browser, the browser can receive the instrumented landing page. Upon loading the instrumented landing page the browser can send a query to the experiment server for a determination of which program code section to display to the user.

In some implementations, statistical information associated with the various program code sections can be collected. Statistical information, for example, can include information about which landing page configurations, based upon the program code served to the user, resulted in the highest frequency of, for example, conversion. In some examples, conversions can be identified by a sale. In other examples, conversions can be identified by progression along a goal path. In some implementations, the program code section associated with the landing page configuration having the highest rate of conversion can be identified as the highest performing experiment option.

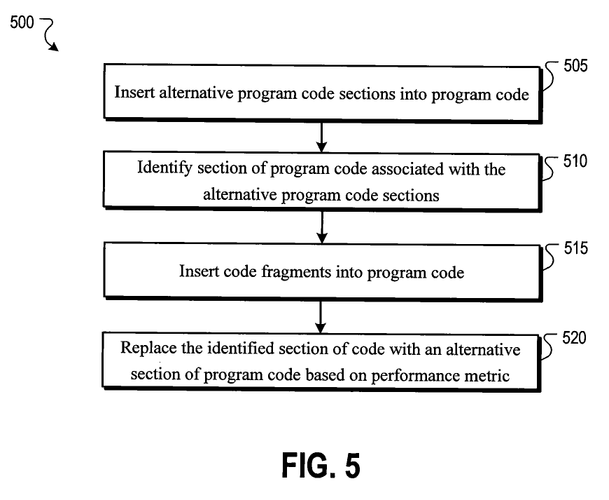

FIG. 5 is a flowchart of an example method 500 for performing code-based website experiments. At stage 505, alternative sections of program code are inserted into program code associated with a landing page. The program code can be inserted, for example, by a publisher (e.g., publisher 110 of FIG. 3) in conjunction with an editor (e.g., editor 310 of FIG. 3). In some implementations, the alternative sections of program code can define different configurations of a landing page. For example, if a publisher wanted to perform an experiment on his/her landing page, the publisher could create alternative program code sections.

At stage 510, a section of program code associated with the alternative program code sections can be identified. The section of program code associated with the alternative program code sections can be identified, for example, by a publisher (e.g., publisher 110 of FIG. 3). In some implementations, the publisher can identify the section of program code that is to be experimented upon. Thus, the identified program code section is identified such that the alternative sections of program code can replace the identified program code section in those landing page configurations that include the alternative sections of program code.

At stage 515, code fragments can be inserted into the program code. In some implementations, the code fragments can be inserted into the program code, for example, by publisher (e.g., publisher 110 of FIG. 3) in conjunction with an editor (e.g., editor 310 of FIG. 3). In some implementations, the code fragments can be inserted into the landing page to produce an instrumented landing page. The code fragments, when loaded with the instrumented landing page by a browser, can be operable to cause the browser to send a query to an experiment server (e.g., experiment server 120 of FIG. 3). The experiment server can randomly select a selected program code section from among the identified program code section and the alternative program code sections. The selected program code section can be communicated to the client device 130 causing the code fragments to generate a landing page configuration using the selected program code section. The experiment server can also collect statistics associated with navigation of the instrumented landing page based upon the presence of the code fragments within the instrumented landing page. For example, the code fragments, when loaded with the instrumented landing page can cause the client device to communicate user navigation of the instrumented landing page or any other page that includes the code fragments. In various implementations, the experiment server can analyze collected statistics associated with the optional program code fragments producing the various landing page configurations and notify the publisher of the results.

At stage 520, an identified section of program code can be replaced with an alternative section of program code based on a performance metric. The identified section of program code can be replaced with an alternative section of program code, for example, by a publisher (e.g., publisher 110 of FIG. 3) in conjunction with an editor (e.g., editor 310 of FIG. 3). Though reference is made to replacing code, other options are possible including merely executing a selected alternative section rather than replacing the code. In various implementations, the performance metric associated with optional program code sections can be derived by navigation statistics collected by an experiment server (e.g., experiment server 120 of FIG. 3). For example, if a landing page included program code sections A, B, C and D, and the publisher decided to experiment on program code section C using alternative program code sections C′ and C″, the experiment server can determine that program code C results in a 10% conversion rate, while alternative program code section C′ results in an 8% conversion rate, and alternative program code section C″ results in an 18% conversion rate. In such example, alternative program code section C″ is identified as the best performing program code section in the experiment. Thus, the publisher can replace program code section C with alternative program code section C″.

The various aspects of the subject matter described in this specification and all of the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims. The same experimental techniques work for any web page, not merely advertising landing pages. Any web site owner can experimentally determine how good his or her web site design is and which web pages should be targeted for improvement. The web site owner merely needs to designate a test page and a goal page. A goal rate can be calculated as the percentage of browsing users who, having reached the test page, go on to reach the goal page. The goal rate can be interpreted as a measure of success. In this specification, in order to adopt the commonly used terminology, “landing page” is used to include all test pages whether or not arrived at through an advertisement, and “conversion page” is used to include all goal pages.

These and other implementations are within the scope of the following claims.

What is claimed is:

1. A method comprising:
identifying a programming code, the programming code having at least one section;
receiving an identification of a first section of programming code;
receiving an identification of a first alternative section of programming code associated with the identified first section of programming code; and
providing code fragments, the code fragments, when executed by a processor, being operable to determine whether to execute the first section of programming code or the first alternative section of programming code when executing the program code.

2. The method of claim 1, further inserting the code fragments into the programming code.

3. The method of claim 1 further comprising embedding the programming code within a web page

4. The method of claim 3, further comprising:
collecting statistics associated with the first section of programming code and the first alternative section of programming code;
wherein the statistics comprise a metric identifying the rate at which users viewing the web page with a respective code section selected a specified link.

5. The method of claim 4, further comprising providing the collected statistics to a user.

6. The method of claim 4, further comprising optimizing performance of a web page including preferentially selecting one of the first section or first alternative section of programming code based on the collected statistics when executing the program code.

7. The method of claim 4, wherein the code fragments, upon execution by the processor, are operable to communicate browsing information associated with a browser viewing the web page to a server, and the step of collecting statistics comprises:
receiving browsing information from the browser; and
compiling the browsing information to provide statistics associated with the respective code section and web page.

8. The method of claim 1, further comprising:
receiving a plurality of alternative sections of programming code;
wherein the provided code fragments, when executed by the processor, are operable to determine whether to execute the first section of programming code or one of the plurality of alternative sections of programming code.

9. The method of claim 8, wherein the provided code fragment determines whether to execute the first section of programming code or one of the plurality of alternative sections of programming code by randomly or pseudo-randomly selecting a section from among the first section of programming code and the plurality of alternative sections of programming code.

10. The method of claim 9, wherein the random or pseudo-random selection of the section of programming code is transparent to a user associated with the processor executing the code.

11. The method of claim 1, wherein the method is performed by software executing on one or more servers.

12. Computer readable media, operable to cause one or more data processing apparatus to perform operations comprising:
identifying programming code, the programming code having at least one section;
receiving an identification of a first section of programming code;
receiving an identification of a first alternative section of programming code associated with the identified first section of programming code; and
providing code fragments, the code fragments, when executed by the processor, being operable to determine whether to execute the first section of programming code or the first alternative section of programming code.

13. The computer readable media of claim 12, further operable to cause one or more data processing apparatus to perform the operation comprising instructing a programmer associated with the programming code to insert the code fragments into the programming code.

14. The computer readable media of claim 12, wherein the programming code is embedded within a web page

15. The computer readable media of claim 14, further operable to cause one or more data processing apparatus to perform the operations comprising
collecting statistics associated with the first section of programming code and the first alternative section of programming code;
wherein the statistics comprise a metric identifying a rate at which users viewing the web page with a respective code section selected a specified link.

16. The computer readable media of claim 15, wherein the code fragments, upon execution by the processor, are operable to communicate browsing information associated with a browser viewing the web page to a server, and the step of collecting statistics comprises:
receiving browsing information from the browser; and
compiling the browsing information to provide statistics associated with the respective code section and web page.

17. The computer readable media of claim 12, further operable to cause one or more data processing apparatus to perform the operation comprising providing the collected statistics to the user.

18. The computer readable media of claim 12, wherein the statistics are used to optimize the performance of a web page based on one of the code sections outperforming other code sections based on a performance metric derived from the statistics.

19. The computer readable media of claim 12, wherein the provided code fragment randomly or pseudo-randomly selects a section for execution from among the first section of programming code and the alternative section of programming code.

20. The computer readable media of claim 12, wherein the method is performed by software executing on one or more servers.

21. A system comprising:
an interface operable to identify programming code comprising one or more sections, the interface further operable to identify a specified section from among the one or more sections of programming code, and one or more alternative sections of programming code; and
a code fragment engine operable to provide code fragments, the code fragments, when executed by a processor, being operable to determine which of the specified section of programming code or any of the one or more alternative sections of programming code to execute.

22. The system of claim 21, wherein the interface is further operable to provide the code fragment engine to a programmer associated with the programming code for insertion into the programming code.

23. A method comprising:
inserting one or more alternative programming code sections into programming code comprising one or more sections of programming code;
identifying a specific section of programming code associated with the one or more alternative sections of programming code, the specific section of programming code being selected from among the one or more sections of programming code;
inserting code fragments into the programming code, the code fragments being operable to cause a processor, upon execution of the code fragments, to select and execute code comprising one of the specific section of programming code or any of the one or more alternative sections of programming code; and
providing the specific section of the programming code with one of the one or more alternative sections of programming code based a performance metric respectively associated with the specific section of the programming code and the one or more alternative sections of programming code.
